(19) United States
(12) Patent Application Publication
(10) Pub. No.: US 2005/0196331 A1
(43) Pub. Date: Sep. 8, 2005

(54) Hazardous vapor mitigation system

(76) Inventor: Jeffrey Dove, Santa Ana, CA (US)

Correspondence Address: PRESTON GATES & ELLIS LLP, 1900 MAIN STREET, SUITE 600, IRVINE, CA, 92614-7319, US

(21) Appl. No.: 10/861,296

(22) Filed: Jun. 4, 2004

Related U.S. Application Data
(60) Provisional application No. 60/476,069, filed on Jun. 4, 2003.

(51) Int. Cl. B01J 19/12

(52) U.S. Cl. 422/186.07

(57) ABSTRACT

A process for removing volatile organic compounds (VOCS) from hazardous waste vapor emitted during liquid hazardous waste clean up and the device for removing volatile organic compounds therein is provided. The process described herein comprises cooling the VOC-laden air stream sufficiently to allow condensation of solvents, passage of the air stream through an ozone-containing environment in the presence of ultraviolet light and finally passage of the air stream through an absorbent filter.

### RELATED APPLICATIONS

The present application claims priority to U.S. Provisional Patent Application Ser. No. 60/476,069 filed Jun. 4, 2003.

### FIELD OF THE INVENTION

The present invention relates to processes and associated devices and methods for hazardous waste vapor and odor mitigation. Specifically, the present invention relates to a hazardous waste vapor/odor mitigation system that utilizes cryogenics, photochemical reactions and absorption means to prevent hazardous waste vapor venting during hazardous waste clean-up operations.

### BACKGROUND OF THE INVENTION

Hazardous wastes are generated in many industrial settings. In particular, gasoline, oil and solvents are hazardous wastes that require specific clean-up procedures. For example, tank farms store liquid hazardous materials in large tanks, either above or below ground and periodically these tanks are cleaned. During the cleaning process, vacuum systems are used to remove residual liquids and vapors from the tanks and store the waste material in disposal trucks. These liquids give off volatile organic compounds in vapor form which need to be mitigated during the clean up process. Present technology passes the vapors generated through activated carbon filters to remove hazardous materials before the air in vented into the environment. The carbon filters absorb solvents present in a vapor state. Using the present technology, these carbon filters become saturated with solvents and water within 30 minutes of a many hour process, necessitating the frequent changing of the filters. In addition, the solvent-laden carbon filters become hazardous waste themselves. The carbon filters can be regenerated with significant financial and times costs.

There are two additional existing technologies to replace the standard activated carbon filters most often used. The first is a standard internal combustion engine in which flammable solvent vapors from hazardous waste clean up are fed into the engine and incinerated. The engine then exhausts to the environment any intact chemical compounds, carbon monoxide, oxides of nitrogen and soot. This system does not substantially reduce the release of pollution to the environment since the air exhaust contains significant hazardous by-products.

Additionally, specific absorbent filters are available for specific hazardous chemicals. In these filters, the absorbent is derivatized to bind specific chemicals or chemical classes. While these filters may provide better removal of solvents from the vapor, the used filters are quickly saturated and continue to add to the hazardous waster disposal problem.

There is also a significant fire and explosion hazard associated with the solvent-laded used charcoal filters and with the internal combustion method of hazardous vapor mitigation. There is therefore an unmet need for more efficient, safer hazardous vapor mitigation systems.

### SUMMARY OF THE INVENTION

The present invention provides a hazardous vapor mitigation system useful in minimizing release of volatile organic compounds and noxious odors into the environment during liquid hazardous waste clean up. The present invention includes a cryogenic component connected to an ozone photoreactor and an absorption filter. In one embodiment, the present invention is a compact, mobile, self-contained unit designed to be transported to liquid hazardous material clean up sites where it removes volatile organic compounds from hazardous air stream prior to venting to the atmosphere. In a second embodiment, the present invention is a large, stationary unit, designed for permanent use at the site of liquid hazardous waste storage, composed of one or more units containing the same functional components as the first embodiment.

In one embodiment of the present invention a hazardous waste vapor mitigation system is provided having at least one first condenser coil for receiving hazardous waste vapor, a coolant substrate for cooling the condenser coil to a temperature sufficient to condense the hazardous waste vapor to form a condensate, a condensate separator for separating the condensate from residual hazardous waste vapor, a collection receptacle for collecting the condensate, a condensate return line for removing the condensate from the hazardous waste vapor mitigation system; and a vapor vent for venting the residual hazardous waste vapor.

In one embodiment of the present invention, at least one filter unit for removing particulates and residual chemicals from the residual hazardous waste vapor is included before venting the residual hazardous waste vapor from the system. The filter materials include activated carbon, electret cloth and an electrostatic collector. In addition the filter can be a hydrogen sulfide absorber such as sodium peroxide-loaded zeolyte clay or dichromate-loaded polymer.

In another embodiment of the present invention an ozone generator included between the condensate separator and the filter unit.

In yet another embodiment of the present invention an ultraviolet (UV) light source is inserted between the ozone generator and the filter unit.

In an embodiment of the present invention, a second condenser coil is connected in series with the first condenser coil and is cooled by a coolant substrate different from the first condenser coil. The possible coolant substrates include dry ice, liquid nitrogen, water ice, blue ice cryogenic mixture, liquid helium, argon and neon. Cooling can also be achieved by means of mechanical refrigeration.

### BRIEF DESCRIPTION OF THE DRAWINGS

FIG. 1 schematically depicts a compact mobile hazardous waste mitigation system.

FIG. 2 schematically depicts an expanded view of the apparatus in FIG. 1.

FIG. 3 schematically depicts a UV/ozone generator.

### DEFINITION OF TERMS

The following definition of terms is provided as a helpful reference for the reader. The terms used in this patent have specific meanings as they relate to the invention's function. Every effort has been made to use terms according to their ordinary and common meaning. However, where a discrepancy exists between the common ordinary meaning and the following definitions, these definitions supercede common usage.

“Hazardous waste:” as used herein hazardous waste is the remains of hazardous materials whose use or disposal poses a threat to human health or the environment.

“Mitigation:” as used herein mitigation is the treating of hazardous waste to render it less hazardous to human health or the environment.

“Absorbent filter:” as used herein an absorbent filter is a material such as activated carbon or electret cloth that retains organic or inorganic chemicals, electrically charged molecules or particulate matter.

“Cryogenic medium:” as used herein cryogenic medium is any substrate that acts as a coolant and has the potential to reduce the temperature of materials it comes in contact with.

“Volatile organic compounds:” as used herein volatile organic compounds are chemicals released in gaseous form from organic liquids, particularly oil-based materials.

### DETAILED DESCRIPTION OF THE INVENTION

In the course of routine hazardous waste removal operations, vacuum trucks are used to collect and remove the liquid material. These trucks discharge a stream of air to the environment that is laden with volatile chemical vapors. This contaminated air stream represents a potentially serious problem due to government regulations, personnel safety and general impact to the local environment for nearby workers, residences and wildlife. Current methods of mitigation of this contaminated air are to direct the exhausted air stream through a bed of activated carbon. Although passage through activated carbon will reduce the organic chemical content, this procedure has a limited capacity to remove large quantities of chemical vapor. Therefore the carbon scrubbers must be replaced a number of times during one typical clean up in order to decrease the volatile organic compound (VOC) load in the exhausted air stream. The replacement process is expensive and labor intensive. In addition, the spent carbon filter material is itself a hazardous waste material that must be treated appropriately. A new hazardous vapor mitigation system is needed that will more efficiently remove the chemical content of vacuum trucks' exhaust system.

The hazardous vapor mitigation system of the present invention is constructed of three distinct components, a condenser component, a reactor component and an absorber component. Additional embodiments of the present invention include of either one, two or all three of these components utilized in tandem.

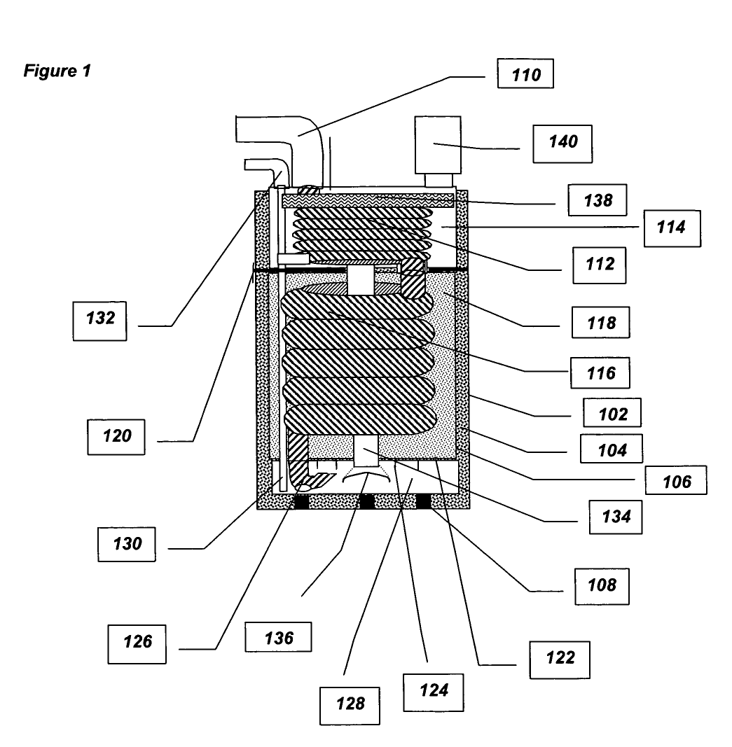

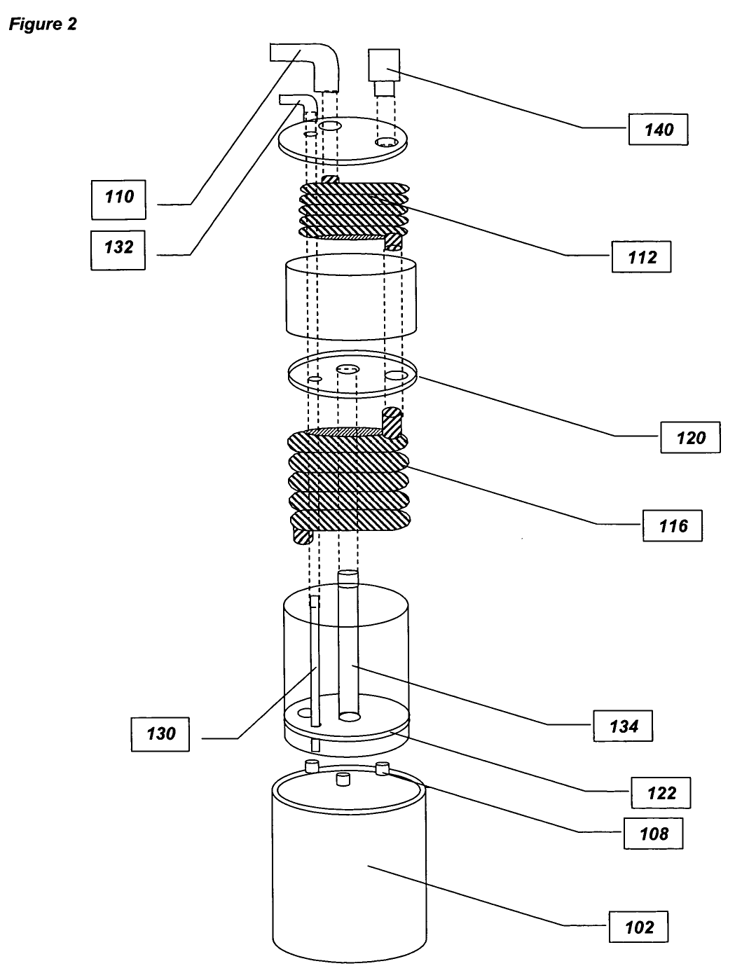

One embodiment of the present invention is depicted in FIG. 1 and FIG. 2. FIG. 2 is an exploded view of the same device depicted in FIG. 1. In FIG. 1, volatile organic compound (VOC)-laden air stream from a vacuum tank truck or other liquid hazardous waste storage or transport vehicle enters the small portable hazardous vapor mitigation system. The hazardous vapor mitigation system is enclosed in a container made up of an outer vessel 102, insulating foam 104 and an inner vessel 106. The outer vessel 102 is a drum that can be constructed from materials including, but not limited to, steel, epoxy-coated steel or stainless steel. The insulating foam 104 can be any insulating material functioning to maintain temperatures at a constant level, including but not limited to polyurethane foam, polystyrene foam, polyethylene foam, or any of the super cryogenic aluminized plastic vacuum insulation materials. The insulating material thickness will vary with insulation efficiency. The inner container 106 can be constructed from any non-reactive metal or solvent-resistant conductive plastic material including, but not limited to, epoxy-coated steel, stainless steel, hard anodized aluminum, conductive polyethylene, conductive polyvinyl chloride or conductive Teflon. The insulating foam and inner container are supported by standoff insulating supports 108 constructed of materials including, but not limited to, high density polyethylene, wood, or hard neoprene rubber.

The VOC-laden air stream enters the present invention though inlet port 110 and then passes into the intercooler heat exchanger coil 112. The intercooler heat exchanger coil allows heat exchange between the incoming warm VOC-laden air stream and the chilled contents of the ultraviolet light (UV)/ozone reaction intercooler space 114. The air stream leaves the heat exchanger and passes over the main condenser coil 116. The main condenser coil is constructed of flexible stainless steel hose and is cooled by cryogenic medium in the cryogenic medium compartment 118 to a temperature of approximately −50° C. or lower. The cryogenic medium can be a coolant substrate including, but not limited to, dry ice, liquid nitrogen, water ice, Blue Ice cryogenic mixture, liquid helium, argon or neon. In addition, cooling can be provided by mechanical refrigeration or a Peltier cooler. The cryogenic medium is contained at the top of the compartment by a hinged lid 120 which allows for re-charging of the cryogenic medium. The hinge is equipped with grounding and bonding cables to provide a ground path from the upper and lower inner containers to the other containers and piping to prevent any static electric charge buildup. Small holes may be provided in the hinged lid to allow sublimated CO₂ to vent into the intercooler chamber to provide additional cooling. At the bottom of the compartment the cryogenic medium is contained by a freeze-out plate 122 with helical air flow guide fins 124. The freeze-out plate is the lowest temperature region of the device and provides means to freeze out the last of any remaining solvent vapors. The helical fins increase surface area of the plate and guide the air stream in a long path to the vent tube 134 to maximize efficiency. The condensation step allows condensation of approximately 60-95% of the VOCs with boiling points from 15° C. to 50° C. and approximately 95-100% of those VOCs with boiling points above 50° C. The condensed vapor collects as a liquid on the surfaces of the main condensation coil and travels via gravitational force through the condensate separator 126 to a collection receptacle 128 at the bottom of the vessel. Solvent-laden condensate is removed from the vessel via a suction tube 130 and exits through suction port 132 back into the vacuum truck tank. Condensate that has frozen onto the condenser coil will be allowed to thaw to a liquid state when the coil temperature is raised to approximately 0° C. after the vacuuming operation is complete and suctioned to the vacuum truck tank.

The air stream leaves the condensation system and collection receptacle 128 via vent tube 134 into the ultraviolet light (UV)/ozone reaction intercooler space 112. Vent tube 134 contains splash cover 136 at its entrance to prevent condensate from entering the intercooler space. The air stream then enters the UV/ozone reaction space in the intercooler or separate chamber. The ozone reacts with and oxidizes thiols (mercaptans), sulfides, thianes and other sulfur-containing compounds. These sulfur-containing compounds are common oil refinery byproducts and are extremely odiferous and noxious and there exists an unmet need to mitigate these compounds. The ozone then can react under the action of an ultraviolet lamp with alkenes, terpenes, alkynes (acetylenes) and additional aromatic compounds that are photochemically reactive. The oxidized reaction products emerging from the UV/ozone reaction chamber have very low residual photochemical activity and low odor. The ozone can be provided by freezing it out directly into the cryogenic media prior to loading into the device. As the cryogen sublimes/boils, it will release a steady concentration of ozone into the UV/ozone reaction intercooler space with no generator system required.

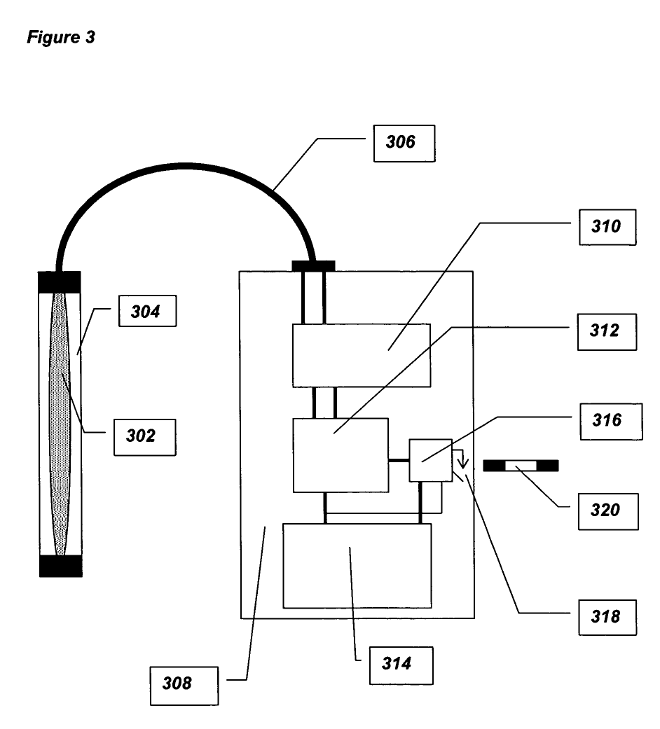

In another embodiment of the present invention, a UV/ozone generator can be placed between the vent tube 134 and the intercooler space 112. As depicted in FIG. 3, the UV/ozone generator contains a 20 watt ozone generating UV lamp 302 housed in a sealed quartz shield 304. The UV lamp is connected by a polymer-filled metal armored cable 306 to a polymer filled/sealed metal case 308. Within the metal case, the armored cable is connected to a solid-state lamp ballast 310, then to the power supply, a 12 volt DC to 120 volt AC inverter 312 and then to a 12 volt DC 10 amp sealed gel cell lead-acid batter 314. On another circuit connected to both the inverter and the battery is a solid-state relay 316 with a magnetic proximity switch 318 to an external magnet 320. The external magnet can be replaced by a pressure or vane-type air flow magnetic or optical switch which causes sparkless switching of the generator only when air is flowing through the device. Additionally, a second magnetically-coupled charging device incorporated into the case would be attached to the battery for charging prior to use.

Any residual electrically-charged molecules and particles and residual reaction products in the air stream are removed by passage through the absorption filter 138. The absorption filter can be constructed of materials including, but not limited to, activated carbon, electret cloth or similar electrostatic collector, or a hydrogen sulfide absorber. The hydrogen sulfide absorber can be, but is not limited to, sodium peroxide-loaded zeolyte clay or dichromate-loaded polymer. The final element of the hazardous vapor mitigation system is a Venturi mixer exhaust stack 140 that dilutes any remaining VOCs vented to the environment.

Flow rates of VOC-laden air through the hazardous waste vapor mitigation system of the present invention are controlled by the size of the hazardous waste vapor source, usually a vacuum truck. Typically, pressure in the system will not exceed approximately 10 pounds per square inch (psi).

The hazardous waste vapor mitigation system of the present invention will additionally be equipped with sealed temperature instrumentation and sensors to determine cryogen levels and VOC and H₂S levels in the air stream.

In another embodiment of the present invention, solvent and water vapor that condenses in the intercooler coil 112 can be suctioned from the base of the intercooler coil through a tee connection to suction tube 130 to prevent unnecessary flooding/freezing of high boiling point compounds in the main condenser coil 116.

In an additional embodiment of the present invention, the hazardous waste mitigation system can be installed as a fixed, in-place unit for use in liquid hazardous waste storage facilities. The in-place device has multiple units to individually house the condensation, UV/ozone reaction and absorption filter components. A separate unit could contain supplementary cryogenic medium or a mechanical refrigeration unit.

### EXAMPLE 1

### Validation Testing of Portable Hazardous Material Mitigation System

All experiments used a 30,000 to 50,000 gallon (113,562-189,271 liter) vacuum truck with a vacuum pump exhausting approximately 500 f³/min. An 8 cm hose connection was made to the device from the vacuum truck tank exhaust, and a 5 cm suction hose connected to a “tee” on an 8 cm hose from the truck's main suction hose. The hazardous waste vapor mitigation system of the present invention (208 L drum inside 322 liter over-pack drum main unit) was equipped with inlet/outlet pressure, inlet/outlet/ and condenser outlet temperature gauges, and a vacuum gauge on the suction port.

In Experiment 1, the job was a one million gallon (3,785 kiloliter) crude oil tank yearly cleanout. The device was tested with 80 kilograms (kg) of dry ice, no intercooler and no vent tube (chilled air stream permeated back through the dry ice). The volatile organic compounds (VOCs) were measured using a photo-ionization (PID) instrument (Model MiniRAE 2000, RAE Systems, Sunnyvale, Calif.).

Initial readings with a sensor at the device exit vent demonstrated a significant drop in solvent load from greater than 100% (sensor read over maximum limit) to less than 13% after 30 minutes. The ambient temperature, heat from the vacuum pump, and compression heating (5 psi) raised inlet temperature from 24° C. to 63° C. This was found to be rapidly subliming the dry ice cryogenic media accompanied by a plume of white dry ice/water vapor “smoke” venting from the device. The temperature of the outlet vent stream was −29° C., indicating a substantial loss of cooling potential in a few hours, not sufficient for a 5-8 hour target job. As a substantial amount of dry ice sublimed, the solvent that had initially “frozen out” in the condensation coil re-vaporized and the VOC levels rose to approximately 50% at three hours. The conclusion of Experiment 1 is that initial efficacy has been demonstrated.

In Experiment 2 the present inventor evaluated intercooler and duration capability. A vent tube and baffle was placed in main unit to limit air stream contact with cryogenic media. A secondary intercooler heat exchanger was placed between the truck exhaust and main unit and was connected to the main unit's outlet port to provide additional cooling. This job was a pump-out/clean-out of an oil field 5,000 gallon (18,927 liter) holding tank containing mainly intermediate crude oil and solvents. Both a PID VOC meter and a “Four Gas” meter (Model VRAE, RAE Systems) were used. The dry ice charge was 91 kg.

The results of Experiment 2 demonstrated an 11-22° C. degree drop in inlet temperatures at the main condenser coil seen with an intercooler in operation. This led to very slow sublimation rate projected to allow the dry ice to last 6-8 hours. Additionally there was no solvent loading on dry ice, no dry ice “smoke” seen and very low VOCs initially, although hydrogen sulfide levels were high. The prototype intercooler design allowed residual solvent to collect in bottom of the heat exchanger and re-contaminate outlet air stream and the VOCs rose after 3 hour run period. The inclusion of an intercooler in the present invention improved efficiency to allow full day runs and redesign of the intercooler prevented recontamination of the air stream.

The results of Experiments 1 and 2 are presented in Table 1.

TABLE 1
Relative Performance for Typical Tank Cleaning Performance¹

| | Run | Inlet | Condenser | |
|---|---|---|---|---|
| System | Duration | Temperature | Temperature | VOC/LEL³ |
| Configuration | Hours | ° C. | ° C. | % |
| None | 0 | 46 | <−40 | >100 |
| Main Condenser | 0.5 | 46 | <−40 | 4-13 |
| Only² | | | | |
| Main Condenser | 3.0 | 60 | −28 | 50 |
| Only | | | | |
| Intercooler + | 0.5 | 41 | <−40 | 8.5 |
| Main Condenser | | | | |
| Intercooler + | 3.0 | 60 | <−40 | 16.7 |
| Main Condenser | | | | |
| Carbon Canister | 0 | na | na | 33 |

¹Intermediate crude oil/water (90/10 mix)
²80-91 kg dry ice charge
³Volatile organic compounds/lower explosion limit. Measured with a photo ionization detector (PID) instrument

In Experiment 3, H₂S mitigation with an ozone generator system was evaluated. A thirty gallon (114 liter) drum containing an ozone-generating ultraviolet (UV) lamp and sealed self-contained power supply was connected to an intercooler unit with a 2.5 cm hose and was further connected to a compressed air source providing the feed air to generate ozone and drive it into the intercooler unit. The job was a pump-out/clean-out of an oil field 20,000 gallon (75,708 liter) “sour water” holding tank containing some crude oil and a preponderance of hydrogen sulfide loaded water. Both PID VOC and “Four Gas” meters were used.

Experiment 3 demonstrated that addition of the ozone generating unit reduced H₂S levels forty percent. The results of Experiment 3 are presented in Table 2.

TABLE 2
Relative Hydrogen Sulfide Mitigation Performance

| | Hydrogen Sulfide |
|---|---|
| System Configuration | ppm¹ |
| Intercooler + Main Condenser | 190 |
| Ozone Generator (UV on)² + Intercooler + Main | 115 |
| Condenser | |

¹Measured with a “Four Gas” instrument
²20 watt UV ozone generator in air stream

1. A hazardous waste vapor mitigation system comprising:
at least one first condenser coil for receiving said hazardous waste vapor,
a coolant substrate for cooling said condenser coil to a temperature sufficient to condense said hazardous waste vapor to form a condensate,
a condensate separator for separating said condensate from residual hazardous waste vapor,
a collection receptacle for collecting said condensate,
a condensate return line for removing said condensate from said hazardous waste vapor mitigation system; and
a vapor vent for venting said residual hazardous waste vapor.

2. The hazardous waste vapor mitigation system according to claim 1 further comprising:
at least one filter unit for removing particulates and residual chemicals from said residual hazardous waste vapor before venting said residual hazardous waste vapor from said hazardous waste vapor mitigation system.

3. The hazardous waste vapor mitigation system according to claim 1 further comprising:
an ozone generator disposed between said condensate separator and said filter unit.

4. The hazardous waste vapor mitigation system according to claim 1 further comprising:
a ultraviolet (UV) light source disposed between said condensate separator and said filter unit.

5. The hazardous waste vapor mitigation system according to claim 4 wherein said UV light source is disposed between said ozone generator and said filter unit.

6. The hazardous waste vapor mitigation system according to claim 1 further comprising:
a second condenser coil in communication with said first condenser coil wherein said second condenser coil is cooled by a coolant substrate different from said first condenser coil.

7. A method for mitigating hazardous waste vapor comprising:
receiving said hazardous waste vapor in at least one first condensing coil,
cooling said condensing coil to a temperature sufficient to condense said hazardous waste vapor to form a condensate,
separating said condensate from residual hazardous waste vapor in a condensate separator,
collecting said condensate in a collection receptacle,
removing said condensate from said hazardous waste vapor mitigation system through a condensate return line; and
venting said residual hazardous waste vapor.

8. The method of mitigating hazardous waste vapor according to claim 7 further comprising:
removing particulates and residual chemicals from said residual hazardous waste vapor with at least one filter unit before venting said residual hazardous waste vapor from said hazardous waste vapor mitigation system.

9. The method of mitigating hazardous waste vapor according to claim 8 wherein said filter is selected from the group consisting of activated carbon, electret cloth and electrostatic collector.

10. The method of mitigating hazardous waste vapor according to claim 9 wherein said filter is electret cloth.

11. The method of mitigating hazardous waste vapor according to claim 8 wherein said filter is a hydrogen sulfide absorber selected from the group consisting of sodium peroxide-loaded zeolyte clay and dichromate-loaded polymer.

12. The method of mitigating hazardous waste vapor according to claim 7 further comprising:
reacting said residual hazardous waste vapor with ozone after exiting said condensate separator.

13. The method of mitigating hazardous waste vapor according to claim 7 further comprising:
exposing said residual hazardous waste vapor to said UV light source after exiting said condensate separator.

14. The method of mitigating hazardous waste vapor according to claim 13 wherein said UV light source is disposed between said ozone generator and said filter unit.

15. The method of mitigating hazardous waste vapor according to claim 7 further comprising:
cooling said hazardous waste vapor with a second condenser coil in communication with said first condenser coil wherein said second condenser coil is cooled by a coolant substrate different from said first condenser coil.

16. The method of mitigating hazardous waste vapor according to claim 7 wherein said coolant substrate is selected from the group consisting of dry ice, liquid nitrogen, water ice, blue ice cryogenic mixture, liquid helium, argon and neon.

17. The method of mitigating hazardous waste vapor according to claim 16 wherein said coolant substrate is dry ice.

18. The method of mitigating hazardous waste vapor according to claim 16 wherein said coolant substrate is liquid nitrogen.

19. The method of mitigating hazardous waste vapor according to claim 7 wherein said cooling is by mechanical refrigeration.

20. A hazardous waste vapor mitigation system comprising:
at least one first condenser coil for receiving said hazardous waste vapor,
a coolant substrate for cooling said condenser coil to a temperature sufficient to condense said hazardous waste vapor to form a condensate,
a condensate separator for separating said condensate from residual hazardous waste vapor,
a collection receptacle for collecting said condensate,
a condensate return line for removing said condensate from said hazardous waste vapor mitigation system,
at least one filter unit for removing particulates and residual chemicals from said residual hazardous waste vapor,
a vapor vent for venting said residual hazardous waste vapor; and
an ozone generator disposed between said condensate separator and said filter unit.

21. The hazardous waste vapor mitigation system according to claim 20 further comprising:
an ultraviolet (UV) light source disposed between said condensate separator and said filter unit.

22. The hazardous waste vapor mitigation system according to claim 20 further comprising:
a second condenser coil in communication with said first condenser coil wherein said second condenser coil is cooled by a coolant substrate different from said first condenser coil.
